(19) United States
(12) Patent Application Publication
(10) Pub. No.: US 2022/0402831 A1
(43) Pub. Date: Dec. 22, 2022

(54) METHOD FOR REMOVING FLUORIDES AND CHLORIDES FROM DRINKING WATER FOR ENHANCED WATERING OF PLANTS

(71) Applicants: Andrew Butler, Markham (CA); Peter Liaw-Morris, Aurora (CA); Michelle Kane, Hamilton Township (CA)

(72) Inventors: Andrew Butler, Markham (CA); Peter Liaw-Morris, Aurora (CA); Michelle Kane, Hamilton Township (CA)

(21) Appl. No.: 17/354,244

(22) Filed: Jun. 22, 2021

(51) Int. Cl. C05C 5/04; C02F 1/70; C02F 1/68; C02F 1/66; C05G 5/23

(52) U.S. Cl. CPC C05C 5/04; C02F 1/70; C02F 1/68; C02F 1/66; C05G 5/23; C02F 2101/14

(57) ABSTRACT

An improved method for treating ordinary tap water to create an enhanced water composition for watering plants which can remove fluoride and chlorides from the tap water, and finally, to treat the enhanced water composition to provide a preferred pH level that is ideal for growing plants, and particularly medically grown cannabis, in order to enhance the uptake of certain nutrients for these plants.

### FIELD OF THE INVENTION

The present invention relates to an improved method for treating ordinary tap water to create an improved water for watering plants, which can remove fluoride and chlorides from the tap water, and finally, to treat such water to provide a preferred pH level that is ideal for growing plants, and particularly medically grown cannabis, in order to enhance the uptake of certain nutrients for these plants.

### DESCRIPTION OF THE PRIOR ART

It is well known that ordinary tap water contains a number of common chemicals. Chlorine (or chloramine) is commonly added to drinking water by municipal water systems as a purification technique, and fluoride has been added to such water for decades to help reduce tooth decay. Water such as this can be used for watering plants, though there are inherent risks in doing so, as hereinafter described.

When watering plants, water is sometimes mixed with a product supplying nutrients that uses beneficial microbes to assist with root development and increase water and nutrient absorption, amongst other things.

However, chlorides and fluoride present in this tap water are both phytotoxic (poisonous to plants) and should be removed prior to mixing in a product supplying nutrients to feed plants, such as medically grown cannabis, because when ordinary tap water is mixed with a product supplying nutrients, much like in a pool having algae, the chlorides in ordinary tap water can indeed “shock” the nutrient solution, but can also kill any beneficial microbes in that solution. Moreover, in addition to being phytotoxic, fluoride in ordinary tap water inhibits photosynthesis and other processes of the plant as it moves through the transpiration stream, moving from the roots to the stomata.

Traditionally, the removal of chlorine from such ordinary water, after removal with a chemical, can involve filling a reservoir, and letting the chlorine dissipate over a 24 hour period. If chloramine is present however, this will not dissipate for approximately 30 days. In order to bypass the above-noted time periods, or to remove all unwanted chemical and minerals, growers often use reverse osmosis systems. These remove common chemical contaminants, including chlorine, chloramine and fluoride. Reverse osmosis systems can be quite expensive, and waste a substantial amount of water, as they are only about 25% efficient.

Furthermore, when growing plants, typically such plants uptake nutrients best within a certain pH range. A pH level of between 5.8-6.2, for example, is ideal for growing plants, and particularly medically grown cannabis, in order to uptake certain nutrients such as nitrogen phosphorus, potassium, calcium, sulphur, magnesium, iron, manganese, boron, copper, zinc, and molybdenum.

Accordingly, there is a need for a method of treating ordinary tap water to create an improved and enhanced water composition for watering plants, which can remove fluoride to prevent (for example) leaf necrosis, short brown roots, fungal issues, weak stems and stunted growth. There is a further need for a method of treating ordinary tap water to remove chlorides from the tap water, and finally, to treat the water to provide a pH level of between 5.8-6.2, for example, that is ideal for growing plants, and particularly medically grown cannabis, in order to enhance the uptake of certain nutrients such as nitrogen phosphorus, potassium, calcium, sulphur, magnesium, iron, manganese, boron, copper, zinc, and molybdenum.

To this end, the present invention effectively addresses this need.

### SUMMARY OF THE INVENTION

A general object and advantage of the present invention is to provide an improved method for treating ordinary tap water to create an improved water composition for watering plants, which can remove fluoride and chlorides from the tap water.

A still further object and advantage of the present invention is to provide an improved method for treating ordinary tap water to provide a preferred pH level that is ideal for growing plants, and particularly medically grown cannabis, in order to enhance the uptake of certain nutrients in growing such plants.

According to one aspect of the present invention, there is provided a method for treating tap water to create an enhanced water composition for watering plants comprising the steps of delivering a pre-set amount of calcium nitrate to the tap water to remove fluoride from the tap water; and delivering a pre-set amount of sodium thiosulfate to the tap water to remove chlorides from the tap water.

According to another aspect of the present invention, there is provided a use of calcium nitrate for treating tap water to create an enhanced water composition for watering plants, wherein calcium nitrate is introduced at a ratio of between 0.06 grams to 4.3 grams for every 1000 ml of tap water to be treated.

According to another aspect of the present invention, there is provided a use of a compound for treating tap water to create an enhanced water composition for watering plants, the compound being selected from the group consisting of calcium nitrate, calcium nitrite, magnesium sulfite, magnesium sulfate and magnesium nitrite, wherein the compound is introduced in an amount of about 100 ml for every 1000 ml of tap water to be treated.

According to another aspect of the present invention, there is provided a method for treating tap water to create an enhanced water composition for watering plants, wherein creating the enhanced water composition comprises the steps of delivering a pre-set amount of sodium citrate dihydrate to the tap water to adjust a pH level of the enhanced water composition to a pre-set level; delivering a pre-set amount of citric acid to the tap water to adjust a pH level of the enhanced water composition to a pre-set level; delivering a pre-set amount of calcium nitrate to the tap water to remove fluoride from the tap water; and delivering a pre-set amount of sodium thiosulfate to the tap water to remove chlorides from the tap water.

### DESCRIPTION OF THE PREFERRED EMBODIMENT

The present invention relates to an improved method for treating ordinary tap water to create an enhanced water composition for watering plants, which can remove fluoride and chlorides from the tap water, and finally, to treat such water to provide a preferred pH level that is ideal for growing plants, and particularly medically grown cannabis, in order to enhance the uptake of certain nutrients for these plants.

In an exemplary embodiment, the method and use of the present invention is used to create an enhanced water composition for watering plants in a concentrated formula designed to be used, preferably, at about 100 ml for every 1000 ml (1 litre) of liquid to be treated, but this can be varied, for example from 80 ml to 120 ml for every 1000 ml of liquid to be treated. Other variations to this range are also possible, as would be understood by one skilled in the art.

An exemplary embodiment of the present invention is to remove both fluoride and chlorides from tap water in creating the enhanced water composition, and, as an alternate, cost-effective, and more environmentally friendly approach to remove chlorides rather than using expensive reverse osmosis systems, the present invention utilizes sodium thiosulfate to remove these chlorides from the tap water. The sodium thiosulfate binds with the chlorides and turns it into salt. This method of dechlorination is commonly used in aquariums, and sold as water conditioners, for example.

In an exemplary embodiment, the amount of sodium thiosulfate introduced into the tap water to create the enhanced water composition is, preferably, 0.62 grams, but this can also range from 0.09 g up to 6.2 g, though it will be understood that variations to this range are possible, as would be understood by one skilled in the art. It will also be understood that the sodium thiosulfate introduced into the tap water, as well as all other additions hereinafter noted, together comprise the concentrated formula designed to be used, preferably, at about 100 ml for every 1000 ml of liquid to be treated.

As noted previously, fluorides are also removed from the tap water in the method of the present invention, and for this fluoride removal calcium nitrate is utilized to be introduced into the tap water. It should be noted that calcium nitrate is actually used as a fertilizer, so it's completely safe for plants, it just has the side effect of removing the fluoride, and, when the calcium nitrate is combined with fluoride in the tap water, it creates the natural form of fluoride, calcium fluoride.

Once introduced, this calcium nitrate can be used to assist to, for example, prevent leaf necrosis, short brown roots, fungal issues, weak stems and stunted growth. The calcium also assists with nutrient uptake, promotes proper plant cell elongation, strengthens the cell wall structure, participates in the enzymatic and hormonal processes, and helps protect the plant against stress and diseases.

In an exemplary embodiment, the amount of calcium nitrate introduced into the tap water to create the enhanced water composition is, preferably, 0.43 grams for every 1000 ml of liquid to be treated, but this can also range from 0.06 grams to 4.3 g, though it will be understood that variations to this range are possible, as would be understood by one skilled in the art.

It should be noted that alternatives to utilizing calcium nitrate to remove fluorides can include other fluorine precipitates such as calcium nitrite, magnesium sulfite, magnesium sulfate, magnesium nitrite and magnesium nitrate. Preferably though, it is calcium nitrate that is used. The benefit of using calcium nitrate is that it reacts with fluoride and creates calcium fluoride, which is the natural form of fluoride, which is usually found in soil.

Next, it is known that, when growing plants, such plants uptake nutrients best within a certain pH range in order to uptake certain nutrients such as nitrogen phosphorus, potassium, calcium, sulphur, magnesium, iron, manganese, boron, copper, zinc, and molybdenum, for example. A pH of 5.8-6.2, for example, is ideal for growing medically grown cannabis. This water treatment method of the present invention could also be used for other plants as well, to adjust the pH to best suit their needs.

For example, a pH of 5.5 for apple trees could be obtained, peach trees at 6.5, bonsai at 7.0, as minor examples. To create such a modified pH level then, as such, two further additives are introduced into the tap water to create the enhanced water composition. These being sodium citrate dihydrate and citric acid.

In an exemplary embodiment, the amount of sodium citrate dihydrate introduced into the tap water to create the enhanced water composition is, preferably, 24 grams, but this can also range from 2.4 grams to 72 grams for every 1000 ml of liquid to be treated. Citric acid is introduced into the tap water at a ratio of, preferably, 3.4 grams but this can also range from 0.34 grams to 10.2 grams for every 1000 ml of liquid to be treated. It will also be understood that variations to the above-noted ranges are possible, as would be understood by one skilled in the art.

In creating the enhanced water composition via the method of the present invention, first, the citric acid and sodium citrate dihydrate are added, and allowed to be mixed (stirred) and to dissolve in the tap water to be treated. After waiting approximately 2 to 5 minutes, this will be followed by the addition of the sodium thiosulfate and calcium nitrate, which can be added simultaneously, or one after the other. It will also be understood that variations to the waiting time noted above can be varied, as would be understood by one skilled in the art.

After the introduction of the sodium thiosulfate and calcium nitrate in the tap water to be treated, a further waiting time of approximately 2 to 5 minutes occurs, though again, it will be understood that variations to this waiting time can be varied.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. A method for treating tap water to create an enhanced water composition for watering plants, wherein creating the enhanced water composition comprises the steps of:
delivering a pre-set amount of calcium nitrate to the tap water to remove fluoride from the tap water; and
delivering a pre-set amount of sodium thiosulfate to the tap water to remove chlorides from the tap water.

2. The method of claim 1, further comprising the step of delivering a pre-set amount of sodium citrate dihydrate and citric acid to the tap water to be treated to adjust a pH level of the enhanced water composition to a pre-set level.

3. The method of claim 2, wherein the pre-set level of the pH level is adjusted to be between 5.5 to 7.0.

4. The method of claim 2, wherein the pre-set level of the pH level is adjusted to be between 5.8 to 6.2.

5. The method of claim 1, further comprising the step of delivering the pre-set amount of sodium thiosulfate to the tap water to be treated in an amount of about 0.62 grams for every 1000 ml of the tap water to be treated.

6. The method of claim 1, further comprising the step of delivering the pre-set amount of sodium thiosulfate to the tap water to be treated in a range of between 0.09 grams to 6.2 grams for every 1000 ml of the tap water to be treated.

7. The method of claim 1, further comprising the step of introducing the enhanced water composition to the tap water in an amount of about 100 ml for every 1000 ml of the tap water to be treated.

8. The method of claim 2, further comprising the step of delivering the sodium citrate dihydrate to the tap water in an amount of about 24 grams for every 1000 ml of the tap water to be treated.

9. The method of claim 2, further comprising the step of delivering the sodium citrate dihydrate to the tap water in an amount in a range of between 2.4 grams to 72 grams for every 1000 ml of the tap water to be treated.

10. The method of claim 2, further comprising the step of delivering the citric acid to the tap water in an amount of about 3.4 grams for every 1000 ml of the tap water to be treated.

11. The method of claim 2, further comprising the step of delivering the citric acid to the tap water in a range of between 0.34 grams to 10.2 grams for every 1000 ml of the tap water to be treated.

12. The method of claim 1, further comprising the step of delivering the pre-set amount of calcium nitrate to the tap water to be treated in an amount of about 0.43 grams for every 1000 ml of the tap water to be treated.

13. The method of claim 1, further comprising the step of delivering the pre-set amount of calcium nitrate to the tap water to be treated in a range of between 0.06 grams to 4.3 grams for every 1000 ml of the tap water to be treated.

14. A method for treating tap water to create an enhanced water composition for watering plants, wherein creating the enhanced water composition comprises the steps of:
delivering a pre-set amount of sodium citrate dihydrate to the tap water to adjust a pH level of the enhanced water composition to a pre-set level;
delivering a pre-set amount of citric acid to the tap water to adjust a pH level of the enhanced water composition to a pre-set level;
delivering a pre-set amount of calcium nitrate to the tap water to remove fluoride from the tap water; and
delivering a pre-set amount of sodium thiosulfate to the tap water to remove chlorides from the tap water.

15. Use of calcium nitrate for treating tap water to create an enhanced water composition for watering plants, wherein calcium nitrate is introduced in a range of between 0.06 grams to 4.3 grams for every 1000 ml of the tap water to be treated.

16. The use of claim 9, wherein the enhanced water composition further comprises introducing sodium thiosulfate in an amount of between 0.09 grams to 6.2 grams for every 1000 ml of tap water to be treated.

17. The use of claim 16, wherein the enhanced water composition further comprises introducing sodium citrate dihydrate in an amount of between 2.4 grams to 72 grams for every 1000 ml of the tap water to be treated.

18. The use of claim 16, wherein the enhanced water composition further comprises introducing citric acid in an amount of between 0.34 grams to 10.2 grams for every 1000 ml of the tap water to be treated.
